(19) United States
(12) Patent Application Publication
(10) Pub. No.: US 2018/0162168 A1
(43) Pub. Date: Jun. 14, 2018

(54) Tire Comprising Working Layers Formed By Individual Wires

(71) Applicant: COMPAGNIE GENERALE DES ETABLISSEMENTS MICHELIN, Clermont-Ferrand (FR)

(72) Inventors: Claudia NAVARRO-LOSADA, Clermont-Ferrand Cedex 9 (FR); Aurore LARDJANE, Clermont-Ferrand Cedex 9 (FR); Jean-François PARMANTIER, Clermont-Ferrand Cedex 9 (FR); Vincent MARTIN, Clermont-Ferrand Cedex 9 (FR)

(21) Appl. No.: 15/574,931

(22) PCT Filed: May 11, 2016
(86) PCT No.: PCT/EP2016/060593

§ 371 Date: Nov. 17, 2017

(30) Foreign Application Priority Data
May 18, 2015 (FR) 1554395

(51) Int. Cl. B60C 9/28; B60C 9/20

(52) U.S. Cl. CPC B60C 9/28; B60C 9/2006; B60C 2009/2016; B60C 2200/06; B60C 2009/2051; B60C 2009/2077; B60C 2009/2067; B60C 2009/2019

(57) ABSTRACT

Tire comprising a crown reinforcement formed of four working crown layers of reinforcing elements. In a meridian plane, the thickness of the four working crown layers, measured in the equatorial plane, is less than 5 mm, the reinforcing elements of the four working crown layers being individual metal wires of diameter less than 0.50 mm, the distance between the reinforcing elements, measured along the normal to the direction of the mean line of the wire, being strictly less than 1 mm, and the axial width of each of the four working crown layers being greater than 60% of the axial width of the tread.

The present invention relates to a tire having a radial carcass reinforcement, and more particularly a tire intended for fitting to vehicles that carry heavy loads, such as lorries, tractors, trailers or buses, for example.

In general, in tires for heavy-duty vehicles, the carcass reinforcement is anchored on each side in the bead region and is surmounted radially by a crown reinforcement made up of at least two superposed layers formed of wires or cords which are parallel within each layer and crossed from one layer to the next, making angles of between 10° and 45° with the circumferential direction. The said working layers that form the working reinforcement may furthermore be covered with at least one layer, referred to as a protective layer, formed of reinforcing elements which are advantageously metallic and extensible and referred to as elastic reinforcing elements. It may also comprise a layer of metal wires or cords having low extensibility, forming an angle of between 45° and 90° with the circumferential direction, this ply, referred to as the triangulation ply, being located radially between the carcass reinforcement and the first crown ply, referred to as the working ply, formed of parallel wires or cords lying at angles not exceeding 45° in terms of absolute value. The triangulation ply forms a triangulated reinforcement with at least the said working ply, this reinforcement having low deformation under the various stresses which it undergoes, the triangulation ply essentially serving to absorb the transverse compressive forces that act on all the reinforcing elements in the crown area of the tire.

Cords are said to be inextensible when the said cords, under a tensile force equal to 10% of the breaking force, exhibit a relative elongation of at most 0.2%.

Cords are said to be elastic if the said cords have a relative elongation of at least 3% under a tensile load equal to the breaking load, with a maximum tangent modulus of less than 150 GPa.

Circumferential reinforcing elements are reinforcing elements which form angles to the circumferential direction in the range +2.5°, −2.5° around 0°.

The circumferential direction of the tire, or longitudinal direction, is the direction corresponding to the periphery of the tire and defined by the direction in which the tire runs.

The transverse or axial direction of the tire is parallel to the axis of rotation of the tire.

The radial direction is a direction which intersects the axis of rotation of the tire and is perpendicular thereto.

The axis of rotation of the tire is the axis about which it turns in normal use.

A radial or meridian plane is a plane which contains the axis of rotation of the tire.

The circumferential median plane, or equatorial plane, is a plane perpendicular to the axis of rotation of the tire and which divides the tire into two halves.

For metal wires or cords, force at break (maximum load in N), breaking strength (in MPa) and elongation at break (total elongation in %) are measured under tension in accordance with Standard ISO 6892, 1984.

Certain present-day tires, referred to as “road tires”, are intended to run at high average speeds and over increasingly long journeys, because of improvements to the road network and the growth of motorway networks worldwide. The combined conditions under which such a tire is called upon to run undoubtedly make it possible to increase the distance covered, since tire wear is lower. This increase in life in terms of distance covered, combined with the fact that such conditions of use are likely, under heavy load, to result in relatively high crown temperatures, dictates the need for an at least proportional increase in the durability of the crown reinforcement of the tires.

This is because stresses are present in the crown reinforcement; more particularly, there are shear stresses between the crown layers which, in the case of an excessive rise in the operating temperature at the ends of the axially shortest crown layer, result in the appearance and propagation of cracks in the rubber at the said ends. The same problem exists in the case of edges of two layers of reinforcing elements, the said other layer not necessarily being radially adjacent to the first layer.

In order to improve the endurance of the crown reinforcement of the tires, the French application FR 2 728 510 proposes arranging, on the one hand, between the carcass reinforcement and the crown reinforcement working ply that is radially closest to the axis of rotation, an axially continuous ply which is formed of inextensible metal cords that form an angle at least equal to 60° with the circumferential direction and of which the axial width is at least equal to the axial width of the shortest working crown ply and, on the other hand, between the two working crown plies, an additional ply formed of metal elements that are oriented substantially parallel to the circumferential direction.

In addition, French application WO 99/24269 notably proposes, on each side of the equatorial plane and in the immediate axial continuation of the additional ply of reinforcing elements substantially parallel to the circumferential direction, that the two working crown plies formed of reinforcing elements crossed from one ply to the next be coupled over a certain axial distance and then uncoupled using profiled elements of rubber compound over at least the remainder of the width that the said two working plies have in common.

The layer of circumferential reinforcing elements is usually formed by at least one metal cord wound to form a turn of which the angle of lay with respect to the circumferential direction is less than 8°. The cords initially manufactured are coated with a rubber compound before being laid. This rubber compound will then penetrate the cord under the effect of the pressure and temperature during the vulcanizing of the tire.

The results thus obtained in terms of endurance and wear in the case of prolonged road running at high speed are usually satisfactory. However, it would seem that, under certain running conditions, certain tires sometimes exhibit more pronounced wear on a part of their tread. This phenomenon is accentuated when the width of the tread increases.

Moreover, whatever the envisaged solutions such as those as set out above, the presence of a layer of additional reinforcing elements results in a greater mass of the tire and higher tire manufacturing costs.

Document WO 10/069676 proposes a layer of circumferential reinforcing elements distributed at a variable spacing. Depending on the spacings chosen, more widely spaced in the central and intermediate parts of the layer of circumferential reinforcing elements, it is possible to create tires that have satisfactory performance in terms of endurance with improved performance in terms of wear. Moreover, compared with a tire comprising a layer of circumferential reinforcing elements distributed at a constant spacing, it is possible to reduce the mass and cost of such tires, even though it is necessary to make up for the absence of reinforcing elements by using masses of polymer.

It is an aim of the invention to provide tires for “heavy duty” vehicles in which the performance in terms of endurance and wear is retained, or improved, for road use, whatever the conditions of use, and in which the mass is further reduced compared with that of the tires described above.

This objective is achieved according to the invention by a tire with radial carcass reinforcement for a vehicle of the heavy-duty type comprising a crown reinforcement comprising four working crown layers of reinforcing elements, crossed from one layer to the other, making with the circumferential direction angles of between 10° and 45°, which is itself capped radially by a tread, the said tread being connected to two beads by two sidewalls, in a meridian plane, the thickness of the four working crown layers, measured in the equatorial plane, being less than 5 mm, the reinforcing elements of the four working crown layers being individual metal wires of diameter less than 0.50 mm, the distance between the reinforcing elements, measured along the normal to the direction of the mean line of the wire, being strictly less than 1 mm and the axial width of each of the four working crown layers being greater than 60% of the axial width of the tread.

For preference, according to the invention, in a meridian plane, the thickness of the four working crown layers, measured in the equatorial plane, is less than 3.5 mm.

For preference also, according to the invention, the distance between the reinforcing elements, measured along the normal to the direction of the mean line of the wire, is less than 0.5 mm.

For preference also, according to the invention, the axial width of each of the four working crown layers is greater than 80 and preferably less than 95% of the axial width of the tread.

The axial widths of the layers of reinforcing elements are measured on a cross section of a tire, the tire therefore being in a non-inflated state.

The axial width of the tread is measured between two shoulder ends when the tire is mounted on its service rim and inflated to its nominal pressure.

A shoulder end is defined, in the shoulder region of the tire, by the orthogonal projection onto the exterior surface of the tire of the intersection of the tangents to the surfaces of an axially external end of the tread (top of the tread blocks) on the one hand and of the radially external end of a sidewall on the other.

The results obtained with tires according to the invention have effectively demonstrated that, for performance that is at least equivalent in terms of endurance and wear, the tires according to the invention have a lower mass and therefore lower manufacturing costs.

The inventors have been able to demonstrate that this lightening of the tire is connected with a reduction in the thickness of the crown reinforcement as a result of the reduction in the diameter of the reinforcing elements of the working layers. This reduction in the diameter of the reinforcing elements is associated with thicknesses of polymer compound that are reduced by comparison with those of conventional tires and thus an overall thickness of the crown reinforcement that is less than that of conventional tires, despite there being four working crown layers.

The inventors have notably been able to demonstrate that it was possible to reduce the distances between reinforcing elements within one and the same working crown layer by comparison with more conventional designs without adversely affecting the endurance properties of the tire. Specifically, it is commonplace to maintain a minimum distance between the reinforcing elements of one and the same working layer so as to limit the phenomena whereby cracks spread from one element to another.

The inventors believe that the presence of four working layers reduces the risks of cracks appearing at the ends of the working layers because of the distribution of stresses between the various pairs of working layers subjected to cleaving effects. This reduction in the initiation of cracks thus leads to the possibility of reducing the distances between the reinforcing elements.

This reducing of the distances between the reinforcing elements of one and the same working layer contributes to reducing the volume of polymer compound and therefore works in favour of reducing the mass of the tire.

Moreover, the distance between the reinforcing elements, as defined according to the invention, combined with the number of working crown layers, makes it possible to maintain circumferential stiffness properties similar to those of a tire of more conventional design.

At the shoulders of the tire, the circumferential stiffness conferred by the crown reinforcement is even greater than that obtained with conventional tires. The inventors once again believe that the presence of four working layers, leading to a distribution of stress between the various pairs of working layers subjected to cleaving effects and therefore to a reduction in the stresses between each pair of working layers, makes it possible to limit the relative movements of two working layers forming an adjacent pair and thus provides efficient coupling as close as possible to the ends of the said working layers.

The inventors have also demonstrated that the greater circumferential stiffness at the shoulders makes it possible to improve the properties of the tire in terms of wear. Specifically, the appearance of uneven wearing between the center and the edge of the tread that occurs under certain running conditions is reduced by comparison with what may be observed on more conventional designs. The reduction in the diameters of the reinforcing elements of the working layers also makes it possible to reduce the sensitivity of the tire to tread attack, as the crown design according to the invention is more flexible overall than is the case in more conventional tires.

Advantageously according to the invention, in order to obtain satisfactory circumvention stiffnesses, whatever the running conditions, the diameter of the individual metal wires of the four working crown layers is greater than or equal to 0.25 mm.

Advantageously according to the invention, the stiffness per unit width of each of the working crown layers is comprised between 35 and 70 daN/mm.

The stiffness per unit width of a layer of reinforcing elements is determined from measurements taken on reinforcing elements and from the density of reinforcing elements in the layer, which density is itself defined as the number of reinforcing elements per unit width.

The density measurement is performed by visually counting the number of wires present on a non-deformed sample of fabric with a width of 10 cm. The number of wires counted directly gives the value for the density of the fabric in wires/dm.

According to one preferred embodiment of the invention, notably with a view to optimizing the weight savings of the tire, with a working crown layer of reinforcing elements comprising two skim layers between which the reinforcing elements are positioned, the thickness of skim measured in a radial direction on each side of a reinforcing element is less than 0.30 mm. On a tire the thickness of skim is measured by halving the distance between the reinforcing elements of two layers of reinforcing elements in contact with one another.

For preference also according to the invention, the mean angle formed by the reinforcing elements of the said at least two working layers with the circumferential direction is less than 30°. Such angle values make it possible to again limit the relative movements of two working layers as a result of greater circumferential stiffness.

According to an advantageous embodiment of the invention, a layer of rubber compound is arranged between at least the ends of two working crown layers.

The layer of rubber compound can be used to decouple the said working crown layers in order to distribute the shear stresses over a greater thickness. These shear stresses appear in particular as a result of circumferential tensions during passage through the contact area.

Within the meaning of the invention, coupled layers are layers the respective reinforcing elements of which are separated radially from one another solely by the presence of the skim layers with which the said layers are skimmed. In other words, layers which are coupled are layers which are in contact with one another.

The presence of this layer of rubber compound makes it possible in particular to limit the shear stresses between the ends of the working crown layers, the said working crown layers having no circumferential stiffness at their ends.

Advantageously too, according to the invention, a layer of rubber compound is arranged between the ends of two adjacent working crown layers. In other words, according to this advantageous embodiment of the invention, three layers of rubber compound are present between the ends of the four working crown layers.

The layers of rubber compound arranged between the ends of two working crown layers may be identical or alternatively may have thicknesses, measured in the radial direction at the end of the narrowest layer, that vary from one pair of working crown layers to the other.

According to a first alternative form of embodiment of the invention, the two working crown layers radially between a radially innermost working crown layer and a radially outermost working crown layer are axially narrower than the two, radially innermost and radially outermost, working crown layers. The radially innermost working crown layer is therefore advantageously the layer that is axially the widest. This first alternative form of embodiment encourages lower dissipation of heat in the shoulder region of the tire.

According to a second alternative form of embodiment of the invention, the two, radially innermost and radially outermost, working crown layers are axially narrower than the two working crown layers radially between the radially innermost working crown layer and the radially outermost working crown layer. This second alternative form of embodiment is of particular relevance in limiting the damage caused by kerbing. Either: the working crown layer adjacent to the radially innermost layer is the axially widest layer; such a configuration makes it possible to keep the ends of the working layers away from the impact zone. Or: the working crown layer adjacent to the radially outermost layer is the axially widest layer; such a configuration then makes it possible to keep the ends subjected to the impact away from the carcass reinforcement which could be impacted.

According to other alternative forms of embodiment of the invention, a working crown layer radially on the inside or on the outside of the other working crown layers and a working crown layer radially between the radially inner and outer working crown layers are axially wider than the other two working crown layers.

According to another embodiment of the invention, the crown reinforcement is supplemented by a layer of circumferential reinforcing elements.

The presence of a layer of circumferential reinforcing elements goes against the idea of lightening the tire and therefore offsets the performance compromise between lightening and the endurance properties of the tire; the layer of circumferential reinforcing elements may make it possible to improve the endurance of the tire for particularly harsh use.

For preference, at least one layer of circumferential reinforcing elements is radially positioned between two working crown layers.

For preference also, the axial widths of the working crown layers radially adjacent to the layer of circumferential reinforcing elements are greater than the axial width of the said layer of circumferential reinforcing elements.

According to one advantageous embodiment of the invention, the reinforcing elements of at least one layer of circumferential reinforcing elements are metallic reinforcing elements having a secant modulus at 0.7% elongation in the range from 10 to 120 GPa and a maximum tangent modulus of less than 150 GPa.

According to one preferred embodiment, the secant modulus of the reinforcing elements at 0.7% elongation is less than 100 GPa and greater than 20 GPa, preferably in the range from 30 to 90 GPa, and even more preferably less than 80 GPa.

For preference also, the maximum tangent modulus of the reinforcing elements is less than 130 GPa and more preferably less than 120 GPa.

The moduli expressed above are measured on a curve of tensile stress as a function of elongation, the tensile stress corresponding to the tension measured, with a preload of 5 N, with respect to the cross section of metal of the reinforcing element.

According to one preferred embodiment, the reinforcing elements of at least one layer of circumferential reinforcing elements are metal reinforcing elements that have a curve of tensile stress as a function of relative elongation that exhibits shallow gradients for small elongations and a gradient that is substantially constant and steep for greater elongations. Such reinforcing elements of the additional ply are normally known as “bimodulus” elements.

In a preferred embodiment of the invention, the substantially constant steep gradient appears from the point of a relative elongation in the range from 0.4% to 0.7%.

The various characteristics of the reinforcing elements mentioned above are measured on reinforcing elements taken from tires.

Reinforcing elements that are more particularly suitable for creating at least one layer of circumferential reinforcing elements according to the invention are for example assemblies of construction 3×(0.26+6×0.23) 5.0/7.5 SS. Such a cord has a secant modulus at 0.7% equal to 45 GPa and a maximum tangent modulus equal to 100 GPa, these being measured on a curve of tensile stress as a function of elongation, the tensile stress corresponding to the tension measured, with a preload of 5 N, with respect to the cross section of metal of the reinforcing element, of 0.98 mm² in the case of the example in question.

According to a second embodiment of the invention, the circumferential reinforcing elements may be formed of metal elements cut so as to form portions having a length much less than the circumference of the shortest layer, but preferably greater than 0.1 times the said circumference, the cuts between portions being axially offset with respect to one another. Preferably again, the tensile modulus of elasticity per unit width of the additional layer is less than the tensile modulus of elasticity, measured under the same conditions, of the most extensible working crown layer. Such an embodiment makes it possible to confer, in a simple way, on the layer of circumferential reinforcing elements, a modulus which can be easily adjusted (by the choice of the intervals between sections of one and the same row) but which in all cases is lower than the modulus of the layer consisting of the same metal elements but with the latter being continuous, the modulus of the additional layer being measured on a vulcanized layer of cut elements which has been withdrawn from the tire.

According to a third embodiment of the invention, the circumferential reinforcing elements are wavy metal elements, the ratio a/λ of the wave amplitude to the wavelength being at most equal to 0.09. Preferably, the tensile modulus of elasticity per unit width of the additional layer is less than the tensile modulus of elasticity, measured under the same conditions, of the most extensible working crown layer.

A preferred embodiment of the invention also provides for the crown reinforcement to be supplemented radially on the outside by at least one additional layer, referred to as a protective layer, of reinforcing elements that are oriented with respect to the circumferential direction at an angle of between 10° and 45° and in the same direction as the angle formed by the elements of the working layer which is radially adjacent thereto.

According to a first embodiment of the invention, corresponding to conventional tire designs, the reinforcing elements of the protective layer are elastic cords.

According to a second embodiment of the invention, the reinforcing elements of the protective layer are individual metal wires of diameter less than 0.50 mm, the distance between the reinforcing elements, measured along the normal to the direction of the mean line of the wire, being strictly less than 1.5 mm.

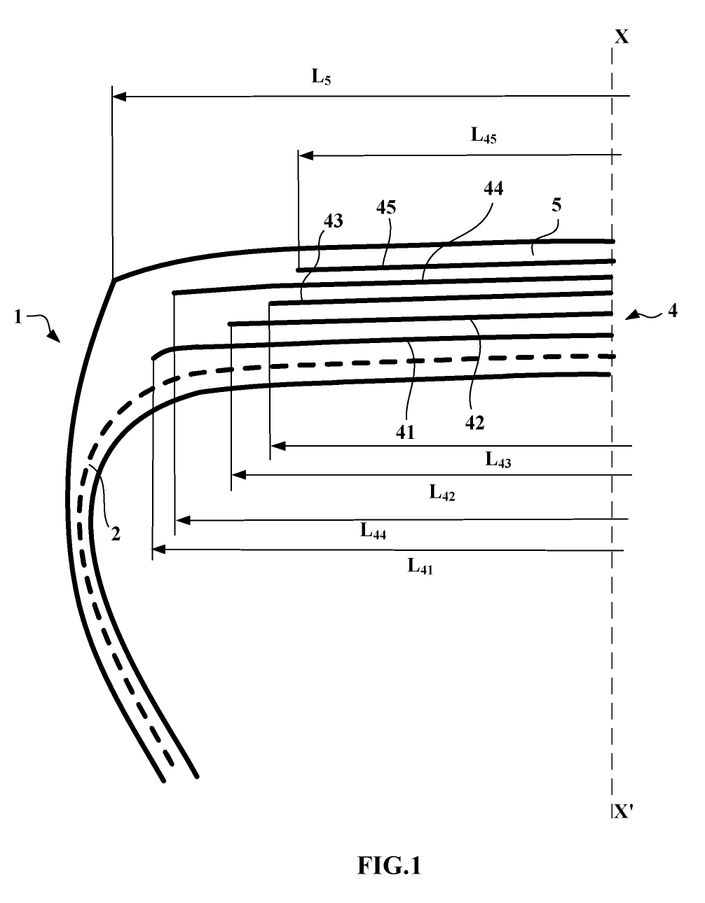

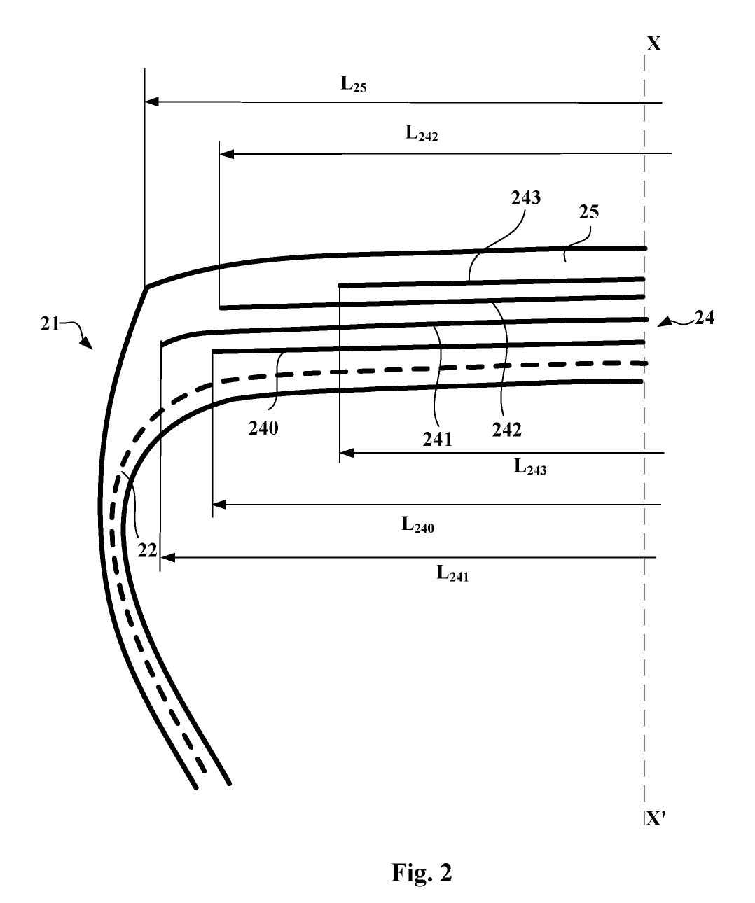

Other advantageous details and features of the invention will become evident hereinbelow from the description of the embodiments of the invention, with reference to FIGS. 1 and 2, which represent:

FIG. 1: a meridian view of a diagram of a tire according to an embodiment of the invention,

FIG. 2: a schematic meridian view of a tire according to the prior art.

In order to make them easier to understand, the figures have not been drawn to scale. The figures represent only a half-view of a tire, which extends symmetrically with respect to the axis XX′, which represents the circumferential median plane, or equatorial plane, of a tire.

In FIGS. 1 and 2, the tires 1, 21, of size 385/55 R 22.5, have an aspect ratio H/S equal to 0.55, H being the height of the tire 1 on its mounting rim and S its maximum axial width. The said tires 1, 21 comprise a radial carcass reinforcement 2, 22 anchored in two beads, not depicted in the figures. The carcass reinforcement 2, 22 is formed of a single layer of metal cords. They further comprise a tread 5, 25.

In FIG. 1, the carcass reinforcement 2 is hooped according to the invention by a crown reinforcement 4 formed radially, from the inside to the outside:
of a first working layer 41 formed of metal wires oriented at an angle equal to 18°,
of a second working layer 42 formed of metal wires oriented at an angle equal to −18°,
of a third working layer 43 formed of metal wires oriented at an angle equal to 18°,
of a fourth working layer 44 formed of metal wires oriented at an angle equal to −18°,
of a protective layer 45 formed of 6.35 elastic metal cords parallel to the metal wires of the working layer 44.

The metal wires that make up the reinforcing elements of the four working layers are wires of the UHT type having a diameter of 0.35 mm Wires of SHT type or of higher grades may also be used. They are distributed within each of the working layers with a distance between the reinforcing elements, measured along the normal to the direction of the mean line of the wire, equal to 0.35 mm.

The axial width L₄₁ of the first working layer 41 is equal to 300 mm.

The axial width L₄₂ of the second working layer 42 is equal to 320 mm.

The axial width L₄₃ of the third working layer 43 is equal to 300 mm.

The axial width L₄₄ of the fourth working layer 44 is equal to 280 mm.

The axial width L₄₅ of the protective layer 45 is equal to 220 mm.

The axial width of the tread, L5, is equal to 312 mm.

The thickness of the four working crown layers, measured in the equatorial plane, is equal to 3.3 mm and therefore less than 5 mm.

In FIG. 2, the carcass reinforcement 22 is hooped by a crown reinforcement 24 formed radially, from the inside to the outside:
of a first triangulation layer 240 formed of non-wrapped 9.35 metal cords oriented at an angle equal to 50°,
of a first working layer 241 formed of non-wrapped 9.35 metal cords, which are continuous across the entire width of the ply, and oriented at an angle equal to 18°,
of a second working layer 242 formed of non-wrapped 9.35 metal cords which are continuous over the entire width of the ply, which are oriented with an angle equal to 18° and which are crossed with the metal cords of the layer 241,
of a protective layer 243 formed of elastic 6.35 metal cords.

The inextensible 9.35 metal cords of the working layers 241 and 242 are distributed within each of the working layers with a distance between the reinforcing elements, measured along the normal to the direction of the mean line of the wire, equal to 1 mm.

The axial width L₂₄₀ of the triangulation layer 240 is equal to 302 mm.

The axial width L₂₄₁ of the first working layer 241 is equal to 318 mm.

The axial width L₂₄₂ of the second working layer 242 is equal to 296 mm.

The axial width L₂₄₃ of the protective layer 243 is equal to 220 mm.

The axial width of the tread, L5, is equal to 312 mm.

The thickness of the three crown layers 240, 241, 242, measured in the equatorial plane, is equal to 6.5 mm.

The combined mass of the four working layers 41, 42, 43 and 44, including the mass of the metal wires and of the skim compounds, thus amounts to 6.3 kg. The mass of the tire according to the invention, produced as depicted in FIG. 1, is equal to 61 kg.

The combined mass of the crown layers 240, 241, 242, including the mass of the metal cords and of the skim compounds, amounts to 12.6 kg. The mass of the tire produced as depicted in FIG. 2, is equal to 67 kg.

Tests were conducted on each of these tires, the tire produced in accordance with FIG. 2 being the reference tire.

First endurance tests were conducted on a test machine, each tire being made to roll in a straight line at a speed equal to the maximum speed rating (or speed index) specified for said tire under an initial load of 4000 kg which was progressively increased to reduce the duration of the test.

Other endurance tests were conducted on a test machine, a transverse force and a dynamic overload being applied to the tires in a cyclic manner. The tests were carried out for the tires according to the invention with conditions identical to those applied to the reference tires.

The tests thus carried out showed that the distances covered during each of these tests are substantially identical for the tires according to the invention and the reference tires. It is thus apparent that the tires according to the invention exhibit a performance in terms of endurance which is substantially the equivalent of that of the reference tires.

Other tests were carried out to evaluate the wear performance of the tires under actual conditions on vehicles. The rolling conditions, in particular the circuit followed, are determined so as to be representative of a particular type of use, in the circumstances use of the motorway type that is more disadvantageous as regards uneven wear. At the end of the running, the wear on the tires according to the invention was found to be more even, indicating potential for increased life.

1. A fire with radial carcass reinforcement for a vehicle of the heavy-duty type comprising a crown reinforcement comprising four working crown layers of reinforcing elements, crossed from one layer to the other, making with the circumferential direction angles of between 10° and 45°, which is itself capped radially by a tread, the said tread being connected to two beads by two sidewalls, wherein, in a meridian plane, the thickness of the four working crown layers, measured in the equatorial plane, is less than 5 mm, wherein the reinforcing elements of the four working crown layers are individual metal wires of diameter less than 0.50 mm, wherein the distance between the reinforcing elements, measured along the normal to the direction of the mean line of the wire, is strictly less than 1 mm, and wherein the axial width of each of the four working crown layers is greater than 60% of the axial width of the tread.

2. The tire according to claim 1, wherein the diameter of the individual metal wires of the four working crown layers is greater than or equal to 0.25 mm.

3. The tire according to claim 1, a working crown layer of reinforcing elements comprising two skim layers between which the reinforcing elements are positioned, wherein the skim thickness measured in a radial direction on each side of a reinforcing element is less than 0.30 mm.

4. The tire according to claim 1, wherein the stiffness per unit width of each of the working crown layers is between 35 and 70 daN/mm.

5. The tire according to claim 1, wherein a layer of rubber compound is arranged between at least the ends of two working crown layers.

6. The tire according to claim 1, wherein the crown reinforcement is supplemented by a layer of circumferential reinforcing elements.

7. The tire according to claim 6, wherein the layer of circumferential reinforcing elements is radially positioned between two working crown layers.

8. The tire according to claim 6, wherein the axial widths of the working crown layers radially adjacent to a layer of circumferential reinforcing elements are greater than the axial width of said layer of circumferential reinforcing elements.

9. The tire according to claim 6, wherein the reinforcing elements of at least one layer of circumferential reinforcing elements are metallic reinforcing elements having a secant modulus at 0.7% elongation in the range from 10 to 120 GPa and a maximum tangent modulus of less than 150 GPa.

10. The tire according to claim 1, wherein the crown reinforcement is supplemented radially on the outside by at least one additional ply, referred to as a protective ply, of reinforcing elements which are oriented with respect to the circumferential direction at an angle of between 10° and 45° in the same direction as the angle formed by the reinforcing elements of the working crown layer radially adjacent to it.
